(19) United States
(12) Patent Application Publication
(10) Pub. No.: US 2025/0036399 A1
(43) Pub. Date: Jan. 30, 2025

(54) Automated Open Source Deprecation Prediction

(71) Applicant: Bank of America Corporation, Charlotte, NC (US)

(72) Inventors: Jack Bishop, III, Evanston, IL (US); Jason Starin, Huntersville, NC (US)

(21) Appl. No.: 18/227,500

(22) Filed: Jul. 28, 2023

(51) Int. Cl. G06F 8/71

(52) U.S. Cl. CPC G06F 8/71

(57) ABSTRACT

A distributed, automated, open-source software (OSS) deprecation-prediction system/process is disclosed. OSS indicia/metadata is retrieved from repositories and stored in a master datastore. OSS metadata is extracted and normalized. Data typification is performed to create static data snapshots, which are stored in a static datastore and provided to a ML surface analytics module, a ML cluster analytics module, and a dynamic data store. ML surface analysis generates rolling time-series n-space vector maps. ML cluster analysis generates time-based cluster analysis data including includes clusters of interior, on-surface, and exterior data points, and a metric for cluster quality for self-reinforcement. An end-of-life (EOL) analytics module generates an EOL deprecation prediction for the OSS based on the dynamic data using ML technique for vectors trending toward the interior or exterior of multi-dimensional vector space.

### TECHNICAL FIELD

The present disclosure relates to neural networks comprising a parallel process performed by a distributed architecture that learns to recognize and classify input data and is constructed in hardware, emulated in software, or a combination of hardware construction and emulation software, and more specifically, for machines and processes for performing machine learning to predict of end-of-life for open-source software.

### DESCRIPTION OF THE RELATED ART

Open source software (OSS) refers to computer software that is made available to users under a license in which the owner of the software's copyright grants users the rights to use, study, modify, and distribute the software as well as its source code to anyone and for any reason. The development of OSS frequently takes place in a public and collaborative setting, and anyone is welcome to make contributions to the project. This can result in software that is more reliable and secure, as well as software that has a wider range of features and functionality.

The process of deprecation is utilized in open-source projects and products incorporating the same. It is standard practice in the software development industry. If a project or code package is considered deprecated, this means that no further work or maintenance will be done on it in the foreseeable future. This may occur for a number of different reasons, including the fact that the project or code has become obsolete, some of the developers have moved on to other projects, or the project/code does not have sufficient on-going community or business support.

A significant problem with deprecation in the context of open-source code is the lack of predictability of end-of-life (EOL) for OSS. This affects the ability of programmers, developers, administrators, designers, system engineers, system architects, etc. to adequately prepare for, develop, test, adopt, transition, and safely implement alternate technology. This results of in crisis-driven development and presents significant technical risks.

Hence there is a long felt and unsatisfied need to provide an automated solution that would analyze open-source repository metadata and source-code commits to determine potential projects or code bases nearing EOL. Such an automated solution would allow appropriate action to be taken in a timely manner and thus minimize technical risks associated with switching to the alternate technology.

### SUMMARY OF THE INVENTION

In accordance with one or more arrangements of the non-limiting sample disclosures contained herein, automated solutions are provided to address one or more of the shortcomings in the field of open-source deprecation prediction by, inter alia: (a) implementing machine learning (ML) managed metadata and code-commit analysis to predict open source end-of-life; (b) utilizing product maturity lifecycle analysis; and/or (c) using predictive visualization of reliability for seeing the data visually.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a distributed, automated, open-source software (OSS) deprecation-prediction process can comprise the following steps: retrieving, from open-source repositories in cloud-service providers, OSS indicia and OSS metadata by a machine learning (ML) retrieval module; storing, in a master OSS datastore, the OSS indicia and corresponding OSS metadata; extracting, from the master OSS datastore based on selected criteria, a subset of the OSS metadata by ML; normalizing, the subset of the OSS metadata, into normalized OSS metadata by a ML normalization module; performing, on the normalized OSS metadata, ML data typification to create static data snapshots by a ML data typification module; storing, in a static datastore, the static data snapshots, and providing the static data snapshots to: a ML surface analytics module, a ML cluster analytics module, and a dynamic data store; performing, on the static data snapshots, surface analysis by the ML surface analytics module to generate time-based surface analysis data and cluster analysis by the ML cluster analytics module to generate time-based cluster analysis data; integrating, into dynamic data in a dynamic data store, the time-based surface analysis data and the time-based cluster analysis data; and generating, by the end-of-life (EOL) analytics module based on the static data snapshots and/or the dynamic data, an EOL deprecation prediction for the OSS.

In some arrangements, a distributed, automated, open-source software (OSS) deprecation-prediction process can comprise the following steps: retrieving, from all publicly available open-source repositories in cloud-service providers, OSS indicia and OSS metadata by a machine learning (ML) retrieval module; storing, in a master OSS datastore, the OSS indicia and corresponding OSS metadata; extracting, from the master OSS datastore based on selected criteria, a subset of the OSS metadata by ML; normalizing, the subset of the OSS metadata, into normalized OSS metadata by a ML normalization module; performing, on the normalized OSS metadata, ML data typification to create static data snapshots by a ML data typification module; storing, in a static datastore, the static data snapshots, and providing the static data snapshots to: a ML surface analytics module, a ML cluster analytics module, and a dynamic data store; performing, on the static data snapshots, surface analysis by the ML surface analytics module to generate a rolling time-series n-space vector map and cluster analysis by the ML cluster analytics module to generate time-based cluster analysis data that includes clusters of interior, on-surface, and exterior data points, and generates a metric for cluster quality for self-reinforcement against at least one baseline, said metric generated using a Calinski-Harabasz/Variance Ratio Criterion; integrating, into dynamic data in a dynamic data store, the rolling time-series n-space vector map and the time-based cluster analysis data; providing, by the surface analytics module to the cluster analytics module, the rolling time-series n-space vector map; providing, by the cluster analytics module to an end-of-life (EOL) analytics module, the cluster analysis; and generating, by the EOL analytics module based on the static data snapshots and/or the dynamic data, an EOL deprecation prediction for the OSS based on an Ordering Points To Identify Clustering Structure (OPTICS) machine learning technique for vectors trending toward the interior, said EOL deprecation prediction being visually presented as one or more multi-dimensional tensors.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a functional, flow diagram showing sample interactions, steps, functions, and components in accordance with one or more OSS deprecation aspects of this disclosure as they relate to ML machines/processes to predict of end-of-life for open-source software.

FIG. 2 depicts sample extraction and retrieval of OSS indicia and OSS metadata from open-source repositories and subsequent normalization and typification of the data into n-vector spatial maps (generically shown, as a simple example, as one or multi-dimensional table(s) 212 with fields).

FIG. 3 depicts a sample EOL candidate in a tensor structure and a sample stable OSS package in a similar structure.

FIG. 4 depicts another sample functional, flow diagram showing sample interactions, steps, functions, and components in accordance with one or more OSS deprecation aspects of this disclosure as they relate to ML machines/processes to predict of end-of-life for open-source software.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure (and the corresponding terminology thereof which may be used interchangeably herein as appropriate), any number of computing devices, computers, computing platforms, distributed architectures, machines, or the like can include one or more configured, customized, physical, general-purpose, network-accessible, special-purpose, and/or virtual devices-whether constructed in hardware, emulated in software, or a combination of hardware construction and emulation software-such as: administrative computers, application servers, clients, cloud devices, clusters, compliance watchers, computing devices, controlled computers, controlling computers, desktop computers, distributed systems, enterprise computers, instances, laptop devices, monitors or monitoring systems, neural networks, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors etc. for executing, accessing, controlling, implementing etc. various software, computer-executable instructions, data, modules, processes, routines, or the like as discussed below.

References to the any of the foregoing may be used interchangeably in this specification and are not considered limiting or exclusive to any type(s) of computers, components, electrical device(s), machines, processes, or the like, etc. Instead, references in this disclosure are to be interpreted broadly as understood by skilled artisans. Further, as used in this specification, the foregoing—whether constructed in hardware, emulated in software, or a combination of hardware construction and emulation software—also include all hardware and components typically contained therein such as, for example, arithmetic and logic units, ASICs, caches, communication buses, control units, clocks, cores, central processing units, digital signal processors, displays, executors, integrated circuits, I/O components, network interfaces, registers, wireless interfaces/protocols (including Bluetooth, cellular, Wi-Fi, ultrawide band, etc.), etc. as well as non-volatile, solid state, volatile, memories or the like, which can include various sectors, locations, structures, or other electrical elements or component. The memory or memories may include: primary memory (i.e., the memory that is directly accessible by the CPU that is used to store the instructions and data that the CPU is currently working on), secondary memory (i.e., the memory that is used to store data that is not currently being used by the CPU, such as flash memory, hard drives, solid state drives, and USB drives, cache memory (i.e., high-speed memory that is used to store data that the CPU has recently accessed that is located between the CPU and primary memory, and that can speed up the access of data by the CPU), register memory (i.e., very high-speed memory that is located inside the CPU that is used to store the data that the CPU is currently working on), and various local/online repositories, databases, datastores, etc.

Other specific or general components, machines, processes, or the like related (or in addition) to any of the foregoing are not depicted in the interest of brevity and would be understood readily by a person of skill in the art.

As used throughout this disclosure, software, computer-executable instructions, data, modules, processes, routines, or the like can include one or more: active-learning, algorithms, alarms, alerts, applications, application program interfaces (APIs), approvals, artificial intelligence, asymmetric encryption (including public/private keys), asynchronous/synchronous functionality, attachments, big data, code bases, code-commit analyses, cluster analyses, crawlers, CRON functionality, daemons, data analysis, data collectors, databases, datasets, datastores, drivers, data structures, data normalizers, data typifiers, emails, emulators, extraction functionality, file systems or distributed file systems, firmware, governance rules, graphical user interfaces (GUI or UI), indicia, indexers, images, instructions, interactions, Java jar files, Java Virtual Machines (JVMs), juggler schedulers and supervisors, keys, lifecycle ownership cost analyses, load balancers, load functionality, machine learning (supervised, semi-supervised, unsupervised, or natural language processing), maintenance, metadata, middleware, minimization analyses, modules, namespaces, objects, open-source code, operating systems, passcodes, passwords, platforms, predictive analyses, predictive visualization, processes, product-maturity lifecycle analyses, protocols, programs, real-time/periodic/on-demand/time interval functionality, search engines, rejections, routes, routines, security, scripts, statistical analyses, surface analyses, tables, tools, transactions, transformation functionality, updaters, user actions, user interface codes, utilities, web application firewalls (WAFs), web servers, web sites, etc.

The foregoing software (including OSS), computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data etc.

As used throughout this disclosure, computer “networks,” topologies, or the like can include one or more public, private, and/or hybrid: asynchronous transfer mode (ATM) networks, cellular networks, cloud networks, distributed networks, the Internet, local area networks (LANs), digital subscriber line (DSL) networks, frame relay networks, metropolitan area networks, personal networks, neural networks, wide area networks (WANs), wired networks, wireless networks, virtual private networks (VPN), and/or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may be synchronous or asynchronous, and may utilize any transport that supports HTTPS or any other type of suitable communication, transmission, and/or other packet-based protocol.

Other specific or general components, communications, machines, networks, processes, OSS, software, or the like, related (or in addition) to any of the foregoing are not depicted in the interest of brevity and would be understood readily by a person of skill in the art. All are considered within the spirit and scope of this disclosure.

In accordance with one or more arrangements of the non-limiting sample disclosures contained herein, automated open-source deprecation prediction solutions are provided to, inter alia: (a) implement machine-learning (ML) managed metadata and code-commit analysis to predict open source end-of-life; (b) utilize product maturity lifecycle analysis; (c) perform lifecycle ownership cost analysis (e.g., filter graphs, etc.) to calculate and analyze cost v. reliability v. time for minimization analysis; (d) use predictive visualization of reliability for seeing the data visually; and/or (e) perform predictive analysis of where computer-managed software maintenance is indicated (i.e., to extend the pre-EOL timeframe).

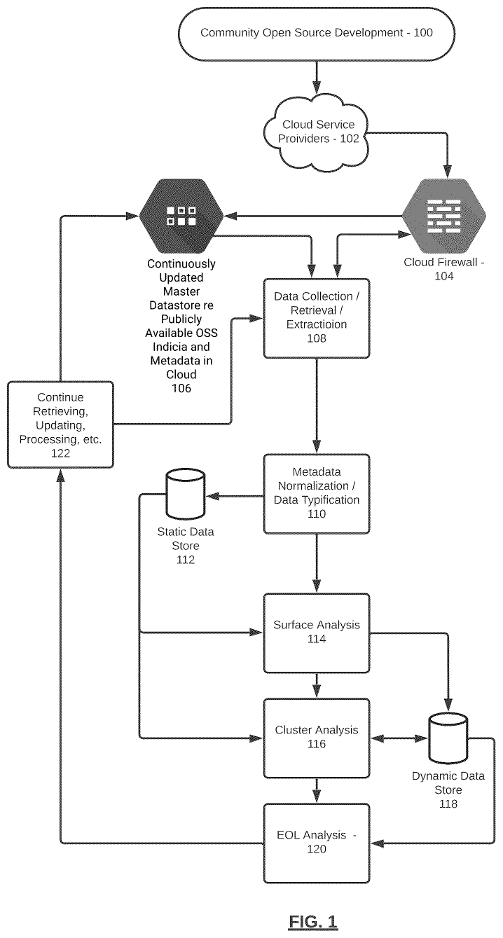

By way of non-limiting disclosure and exemplary description, FIG. 1 depicts a functional, flow diagram showing sample interactions, steps, functions, and components in accordance with one or more OSS deprecation aspects of this disclosure as they relate to ML machines/processes to predict of end-of-life for open-source software.

Community Open Source Development 100 refers to all publicly available open-source software code, components, frameworks, modules, packages, platforms, etc. As referenced previously, the development of OSS frequently takes place in a public and collaborative setting, and anyone is welcome to make contributions to the project. This can result in software that is more reliable and secure, as well as software that has a wider range of features and functionality.

OSS is typically shared in various open-source repositories (e.g., cloud service providers such as 102), which comprise software repositories that are publicly searchable and available. Samples of publicly available open-source repositories include GitHub (the most popular open-source repository hosting service, which offers a variety of features, including version control, code review, and issue tracking), Bitbucket (which is also popular and offers a similar set of features to GitHub), GitLab (which is a self-hosted open-source repository hosting service, and therefore enables businesses and individuals to host their own GitLab servers), and SourceForge (one of the oldest open-source repository hosting services, and offers a variety of features, including bug tracking, mailing lists, and forums).

Access to cloud service providers 102 by individuals and companies may be protected by one or more firewalls. Examples of two types of firewalls that could be used include host-based firewalls (i.e., software firewalls that are installed on individual computers, and monitor and control the traffic that flows to and from the computer), and network-based firewalls (i.e., hardware and/or software firewalls that are installed on a network or its periphery to monitor and control the traffic that flows to and from all of the computers on the network or components of the system in FIG. 1. Firewall techniques as utilized in this disclosure may include packet filtering, stateful inspection, application-level gateways, and the like, etc.

A master datastore 106 of publicly available OSS indicia (e.g., software names, etc.) and OSS metadata (e.g., bug info, code commits, comments, dates, historical information, maintenance information, product lifecycle, project maturity, project status notes, release note analysis, release notes, usage, tickets, version information, etc.) may be coupled to the firewall 104. Open source metadata can be stored in a variety of formats, including JSON, XML, and YAML. It can be managed using a variety of tools, including OpenMetadata, DataHub, Apache Atlas, etc. There are a number of open source metadata fields available. The master datastore may also include source code, archivals, versions, and/or components of the foregoing if desired. Otherwise, it may be limited to OSS indicia and OSS metadata for speed optimization, bandwidth utilization, and memory constraint reasons.

A data collection/retrieval/extraction module 108 can access public OSS, OSS indicia, OSS metadata and the like, through a firewall 104 for safety, and can trigger searching and retrieval of applicable information, indicia, metadata and the like (including code if desired) for storage in the master datastore 106, which is updated continuously, in real-time, at intervals, or on-demand as desired. The goal is to try to acquire as much OSS information (indicia, metadata, etc.) as possible for storage and ultimately for utilization in the steps and modules used for deprecation prediction and EOL analyses. Such OSS information may come directly from the cloud or from the master datastore. The information may also be obtained by data collector 108 and stored in master datastore 106 in parallel if desired. The data collection may be performed asynchronously or otherwise as desired and is collecting as much metadata as possible, bug info, code commits, content delivery networks, historical information, project status notes, release note analysis, release notes, tickets, version information, etc.

OSS indicia and OSS metadata is passed to a metadata normalization/data typification module 110, which is necessary because variations in different field names, variables, and the like (as briefly described above) is not consistent amongst the various repository sources and OSS metadata fields. Hence, ML normalization is required and is the process of transforming metadata into a common format. This can be done to improve the consistency, accuracy, and usability of metadata.

There are a number of different techniques that can be used for metadata normalization. Some common techniques include: data cleansing (removing errors and inconsistencies from the metadata by removing duplicate records, correcting typos, standardizing the format of dates and numbers), data standardization (transforming the metadata into a common format), data reconciliation (comparing different sets of metadata to identify and resolve inconsistencies), and data validation (checking the metadata for accuracy and completeness).

Data typification is the process of assigning a data type to each field in a dataset. Data typification can help to improve the quality of data by ensuring that each field contains the correct type of data. This can help to reduce errors and improve the accuracy of data analysis. Data typification can help to improve the consistency of data by ensuring that each field contains the same type of data. This can help to make data more reliable and easier to use. Data typification can help to improve the usability of data by making it easier to understand and use. This can help to improve the efficiency of data analysis and reporting. Automatic data typification is the preferred method used in this disclosure and involves using a computer program to automatically assign a data type to each field in a dataset.

As used herein, ML managed metadata makes use of machine learning to automatically assign metadata to content or to normalize the content into consistent categories, fields, tags, etc. This can be accomplished by considering a wide range of aspects, including the language, subject matter, and emotional tone of the content. Utilizing machine language to manage metadata in this disclosure presents users with a number of advantageous opportunities. To begin, it may be of assistance in enhancing the precision of metadata tagging. This is due to the fact that algorithms that use machine learning can learn to identify the metadata terms that are most relevant to a specific piece of content. Second, machine language managed metadata can help to cut down on the amount of manual labor needed to tag content.

In the context of this disclosure, it is possible to use ML managed metadata to automatically tag documents with the appropriate subject matter, automatically determine the sentiment of a piece of text, automatically translate documents into various languages, automatically classify documents into various categories, etc. Using ML managed metadata also improves accuracy, which enhances the predictability of OSS deprecation.

In the context of this disclosure, the process of inspecting and analyzing the changes that have been made to a code repository over the course of time is known as code-commit analysis. In the context of this disclosure, this can be utilized to determine whether there are any potential issues, such as security flaws, performance bottlenecks, or code that is no longer required. Code that is not being updated can be found in a repository through the use of code-commit analysis. Finding code that has not been modified in a considerable amount of time or that is not called by any other piece of code is one way to accomplish this.

In other words, this can be an indicator of OSS potentially approaching EOL. Analysis of code commits (a/k/a code-commit analysis) can be performed with the help of a variety of different tools. Examples of code-commit enabling analysis products include: GitLab (for managing Git repositories), GitLab Desktop, the SonarQube platform, and Code Climate.

An increase in the visibility of the changes that have been made to a code repository over the course of time can be achieved through the use of code-commit analysis. This can be of assistance to developers in tracking changes and identifying potential issues, and aids in the predictability of open-source deprecation.

As used herein, product maturity lifecycle analysis refers to a process that evaluates a product's performance over time and identifies its current stage in the product life cycle.

The stages that a product goes through, including OSS, can be conceptualized as moving through what is known as the “product life cycle,” which begins with the product's introduction to the market and ends with the product's eventual demise. The product life cycle is broken up into four distinct stages. The stage known as “introduction” occurs when a product is presented for the very first time. As a result of consumers/developers not yet being familiar with the product, adoption tends to be relatively slow during this stage. The product/OSS is considered to be in the growth stage when its adoption begins to increase at a rapid pace. This is because more people are becoming aware of the product/OSS and because positive word-of-mouth is spreading about it. The stage of maturity is reached when the product has/OSS achieved its highest level of adoption. As the product becomes more established, the rate of growth in adoption or incorporation into other products begins to slow down during this stage. The stage known as “decline” is reached when adoption starts to decrease. This is because of a number of different factors, such as competition from newer software products, newer OSS packages or code bases, changes in consumer or developer preferences, etc.

The outcomes of a product maturity lifecycle analysis can serve as the basis for decision-making concerning the OSS product's trajectory into the future including, but not limited to, predictions of EOL for open-source implementations. For instance, if a product is in the declining stage, companies or developers may choose to either stop using it or to switch to an alternate technology.

As used herein, the use of data visualization to present information regarding the predicted reliability of OSS can be put to use to identify potential problems at an early stage, allowing for preventative maintenance to be carried out in order to reduce the likelihood of expensive breakdowns and also to predict EOL.

In the context of this disclosure, when it comes to using predictive visualization of reliability, there are a variety of approaches that can be taken with respect to OSS. Creating a digital twin of the OSS asset (or system using the same) can then be utilized to simulate a variety of scenarios and determine the likelihood of an outcome being unsuccessful and thus be indicative of a future EOL.

The use of heat maps or other types of graphical representations is yet another strategy that can be implemented in order to identify the components of OSS that are at the highest risk of failing or being deprecated. Once this information is gathered, it can be used to direct maintenance or development efforts toward the areas that have the greatest need for them. Or it can be used as a signal to move away from the OSS or components thereof that are at risk.

In the context of this disclosure, predictive analysis of computer-managed software maintenance refers to a method used to forecast the requirements for software maintenance in the future or potential EOL, if such maintenance or further development does not occur, by utilizing data and various statistical methods.

The age of the OSS, the complexity of the code, the number of changes that have been made to the software, the number of defects that have been found in the OSS, and the historical maintenance data for OSS are some of the factors that can be used in EOL predictive analysis.

The amount of time and effort that will be required for EOL transition to alternate technology can be predicted with the help of predictive analysis, as can the likelihood of defects being found in the software, the impact that changes made to the software will have on its performance, and the requirement for new maintenance tools and techniques.

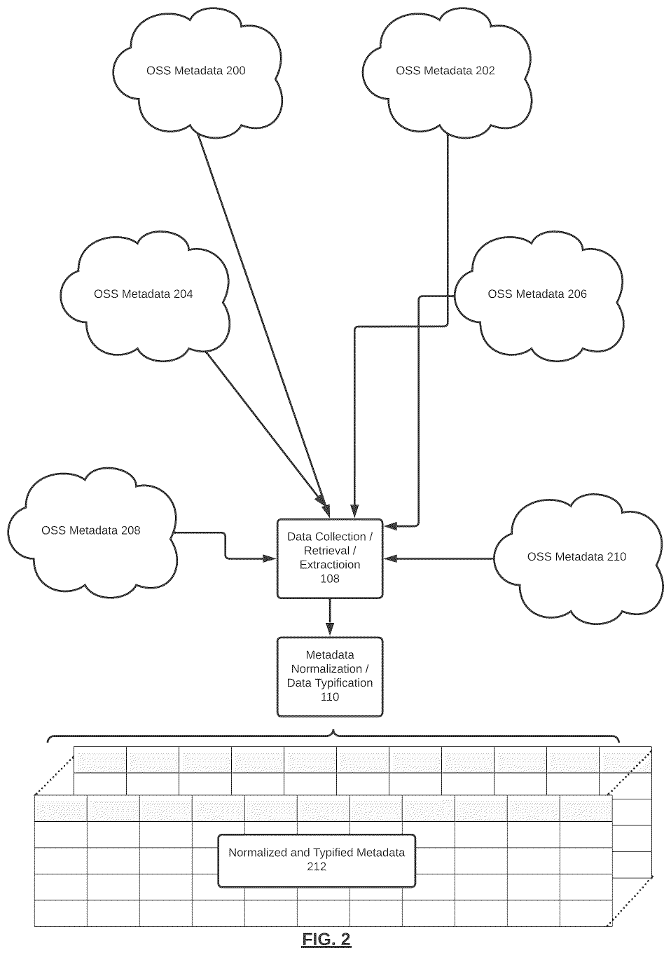

By way of non-limiting disclosure and as a simple example, FIG. 2 depicts extraction and retrieval 108 of OSS indicia and OSS metadata from open-source repositories 200, 202, 204, 206, 208, etc. and subsequent normalization and typification of the data 110 into n-vector spatial maps, which is generically illustrated for simplicity as one or multi-dimensional table(s) 212 of data with metadata field names as headers. (Of course, the table 212 could be in the form of multi-dimensional vectors, shapes, matrices, 3-way tensors, 4-way tensors. . . . N-way tensors or the like.) Various of the foregoing aspects of metadata normalization/data typification 110, which can be combined or omitted as desired, are utilized to generate an n-space vector map (mapping of points in an n-dimensional space to vectors that are used to represent various variables or characteristics of the points) as a fixed snapshot output of the OSS metadata at that particular point in time that is stored in static datastore 112 and also provided to surface analysis module 114 as well as cluster analysis module 116.

Surface analysis module 114 creates a rolling time-series n-space vector surface from the normalized constructs provided as an input thereto. The n-vector surface analysis is a mathematical technique that can be used to represent and analyze surfaces and data characteristics. It is based on the concept of n-vectors, which are vectors that have n components. The n-vector surface analysis technique involves the following steps. The first step is to choose a coordinate system for the surface. The coordinate system will determine the number of components in the n-vectors. The next step is to generate n-vectors for each OSS point on the surface. The n-vectors can be generated using a variety of methods, such as numerical methods or analytical methods. The final step is to analyze the n-vectors to study the properties of the OSS metadata surface. The n-vectors can be analyzed using a variety of methods, such as statistical methods or geometrical methods. The results of the surface analysis in 114 is also provided as an input to cluster analysis 116.

Cluster analysis module 116 creates clusters of interior, on-surface, and exterior using data from the provided inputs via density-based spatial clustering of applications with noise (DBSCAN) machine learning technique or alternate methods described below. Essentially, this is a data mining technique that groups similar data points together.

The goal of cluster analysis is to find groups of data points (called clusters) such that the data points within each cluster are more similar to each other than to data points in other clusters. There are a number of different clustering algorithms available. K-means clustering is a simple and widely used clustering algorithm that works by first choosing a random number of clusters. Then, it iteratively assigns data points to the cluster that they are most similar to. The algorithm continues to iterate until the data points are no longer moving between clusters. Another is hierarchical clustering, which builds a tree-like structure of clusters. The algorithm starts by placing each data point in its own cluster. Then, it iteratively merges the most similar clusters together. The algorithm continues to merge clusters until it reaches a desired number of clusters.

Density-based clustering works by identifying clusters of data points that are densely packed together. This type of clustering is often used for finding outliers or anomalies in data. Density-based spatial clustering of applications with noise (DBSCAN) is a clustering algorithm that groups together points that are densely packed together. It is a non-parametric algorithm, which means that it does not make any assumptions about the distribution of the data. DBSCAN works by identifying points that are considered to be core points. A core point is a point that has a minimum number of points (minPts) within a specified radius (eps). The points within the radius of a core point are considered to be its neighbors.

DBSCAN then identifies clusters by starting with a core point and then adding its neighbors to the cluster. The neighbors of a core point are then added to the cluster, and so on. The process continues until all of the points have been assigned to a cluster. Points that are not core points are considered to be noise. Noise points are not assigned to any cluster.

DBSCAN is beneficial because it does not make any assumptions about the distribution of the data. This makes it a robust algorithm that can be used for a variety of data sets. Also, it can identify clusters of different shapes and sizes. DBSCAN does not require the data to be in a specific shape or size. This makes it a versatile algorithm that can be used for a variety of clustering tasks. It can identify noise points. DBSCAN can identify points that do not belong to any cluster. This can be helpful for identifying outliers or anomalies in the data.

Cluster analysis module 116 can compute a metric for the “quality” of the clustering. This can be used for self-reinforcement against baseline(s). The metric can be calculated by use of the Calinski-Harabasz Index (CH), which is a clustering validation index that evaluates the quality of a clustering solution. It is based on the ratio of the between-cluster variance to the within-cluster variance. The CH index is calculated as follows: CH=(SSb/(k−1))/(SSw/(N−k)) where: SSb is the between-cluster sum of squares; SSw is the within-cluster sum of squares; k is the number of clusters; and N is the total number of data points. The between-cluster sum of squares is the sum of the squared distances between the cluster centroids and the mean of all the data points. The within-cluster sum of squares is the sum of the squared distances between each data point and its cluster centroid.

As a result of the foregoing, the output from the surface analysis and cluster analysis can be stored in a dynamic datastore 118. It is dynamic in that it is always considering prior snapshots of data with currently observed OSS metadata.

Based on the foregoing processing and comparison of current and prior OSS information, an EOL analysis 120 can be performed to predict whether deprecation of the OSS will occur and potentially when it will occur based on a derivative calculation of the rate of change of one or more of the metadata variables.

The EOL analysis 120 can utilize an Ordering Points To Identify the Clustering Structure (OPTICS)) machine learning technique for vectors trending toward the interior. If vectors trend towards the interior, OSS deprecation is more likely and the OSS is a potential EOL candidate. Conversely, if vectors trend towards the exterior, OSS deprecation is not likely at the current point of time in the analysis. But on-going analysis and monitoring is required to see if the likelihood of deprecation changes.

As described above, there are a number of methods for ordering points to identify the clustering structure (OPTICS). Some of the most common methods include: hierarchical clustering (a recursive algorithm that builds a hierarchy of clusters and starts with each point as a separate cluster and then merges clusters that are similar to each other, whereby the order in which the clusters are merged can be used to identify the clustering structure), K-means clustering (an iterative algorithm that partitions the data into k clusters that starts by randomly assigning each point to a cluster, and the algorithm then iterates, moving points from one cluster to another until no points move, whereby the order in which the points are assigned to clusters can be used to identify the clustering structure), DBSCAN clustering (a density-based clustering algorithm that identifies clusters of points that are densely connected that starts by finding points that are not noise, and then expands clusters from these points, whereby the order in which the points are found can be used to identify the clustering structure), mean shift clustering (a non-parametric clustering algorithm that identifies clusters of points that are similar to each other that starts by randomly selecting a point, and then moves the point to the mean of its neighbors, and the algorithm iterates, moving points until they no longer move, whereby the order in which the points move can be used to identify the clustering structure).

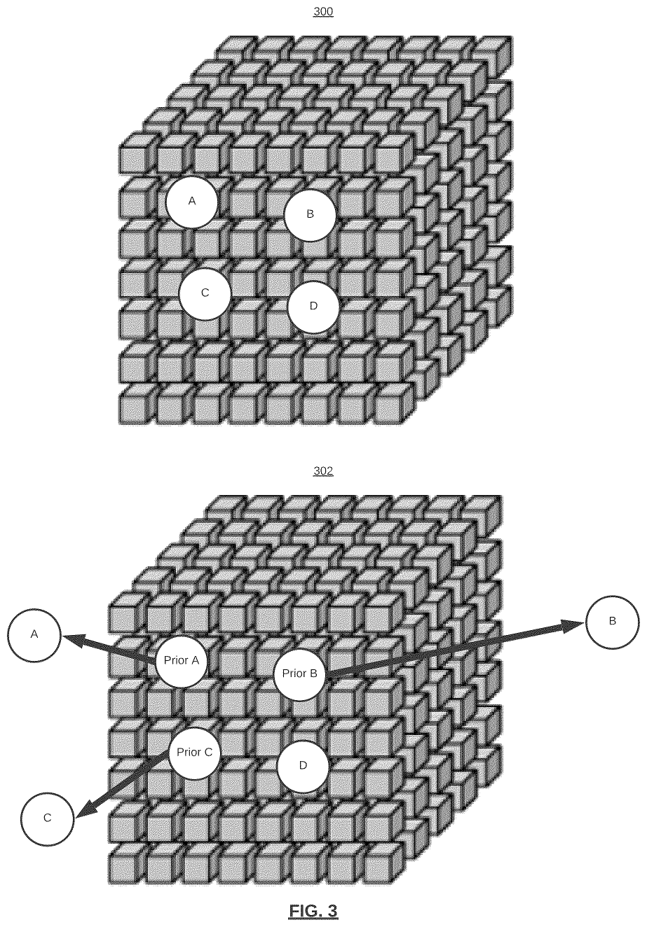

This is illustrated in FIG. 3. Tensor 300 shows interior points of A, B, C, and D. They are all inside the tensor without movement from a prior version and therefore the OSS is not an EOL candidate. Conversely, tensor 302 shows prior points A, B, and C, which have moved outside the shape thereby indicating a negative vector. Point D remains inside the shape in the same position and therefore represents a neutral value. Hence, in this example, tensor 302 is indicative of a potential OSS EOL candidate.

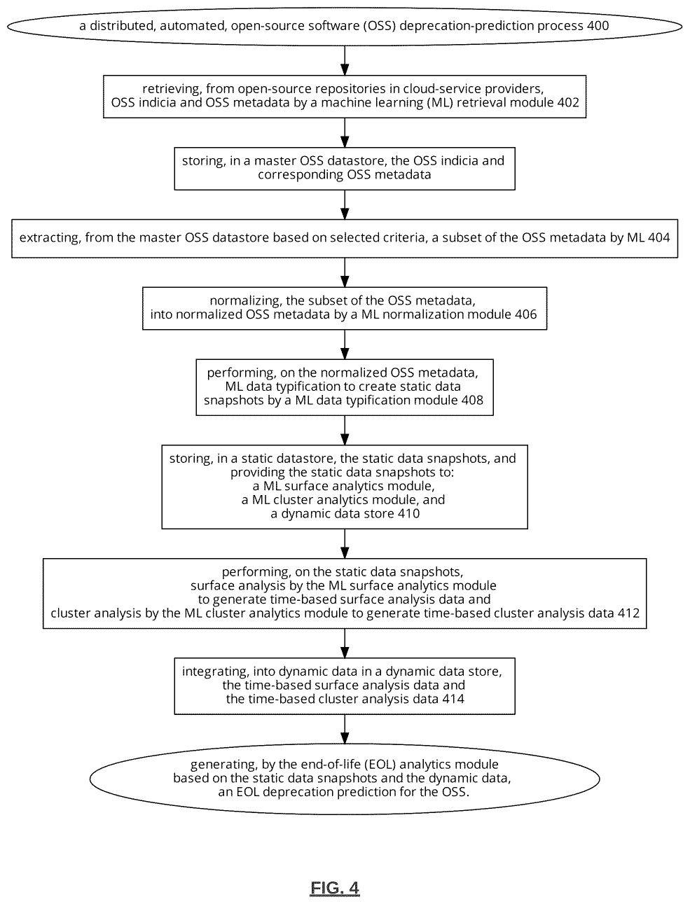

For reference, FIG. 4 depicts another sample functional, flow diagram showing sample interactions, steps, functions, and components in accordance with one or more OSS deprecation aspects of this disclosure as they relate to ML machines/processes to predict of end-of-life for open-source software. In this example, a distributed, automated, open-source software (OSS) deprecation-prediction process 400 can comprise the following steps: retrieving, from open-source repositories in cloud-service providers, OSS indicia and OSS metadata by a machine learning (ML) retrieval module 402; storing, in a master OSS datastore, the OSS indicia and corresponding OSS metadata 404; extracting, from the master OSS datastore based on selected criteria, a subset of the OSS metadata by ML 406; normalizing, the subset of the OSS metadata, into normalized OSS metadata by a ML normalization module 408; performing, on the normalized OSS metadata, ML data typification to create static data snapshots by a ML data typification module 410; storing, in a static datastore, the static data snapshots, and providing the static data snapshots to: a ML surface analytics module, a ML cluster analytics module, and a dynamic data store 412; performing, on the static data snapshots, surface analysis by the ML surface analytics module to generate time-based surface analysis data and cluster analysis by the ML cluster analytics module to generate time-based cluster analysis data 414; integrating, into dynamic data in a dynamic data store, the time-based surface analysis data and the time-based cluster analysis data 416; and generating, by the end-of-life (EOL) analytics module based on the static data snapshots and the dynamic data, an EOL deprecation prediction for the OSS.

In accordance with the disclosures made in this application, the foregoing, individually and collectively, helps to predict OSS EOL, and plan for OSS transitions due to the predicted deprecation.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A distributed, automated, open-source software (OSS) deprecation-prediction process comprising the steps of:
retrieving, from open-source repositories in cloud-service providers, OSS indicia and OSS metadata by a machine learning (ML) retrieval module;
storing, in a master OSS datastore, the OSS indicia and corresponding OSS metadata;
extracting, from the master OSS datastore based on selected criteria, a subset of the OSS metadata by ML;
normalizing, the subset of the OSS metadata, into normalized OSS metadata by a ML normalization module;
performing, on the normalized OSS metadata, ML data typification to create static data snapshots by a ML data typification module;
storing, in a static datastore, the static data snapshots, and providing the static data snapshots to: a ML surface analytics module, a ML cluster analytics module, and a dynamic data store;
performing, on the static data snapshots, surface analysis by the ML surface analytics module to generate time-based surface analysis data and cluster analysis by the ML cluster analytics module to generate time-based cluster analysis data;
integrating, into dynamic data in a dynamic data store, the time-based surface analysis data and the time-based cluster analysis data; and
generating, by the end-of-life (EOL) analytics module based on the dynamic data, an EOL deprecation prediction for the OSS.

2. The distributed, automated, open-source software (OSS) deprecation-prediction process of claim 1 wherein the OSS indicia identifies the source code and the OSS metadata includes: release notes, enhancement tickets, and defect tickets.

3. The distributed, automated, open-source software (OSS) deprecation-prediction process of claim 2 wherein the extracting from the master OSS datastore includes asynchronous data collection of code commits, release note analysis, and ticket analysis from open source repositories.

4. The distributed, automated, open-source software (OSS) deprecation-prediction process of claim 3 wherein the ML data typification normalizes the code commits, the release note analysis, and the tickets onto an N-space vector map.

5. The distributed, automated, open-source software (OSS) deprecation-prediction process of claim 3 wherein the ML surface analytics module creates a rolling time series n-space vector surface from the static data snap shots.

6. The distributed, automated, open-source software (OSS) deprecation-prediction process of claim 5 wherein the ML cluster analytics module creates clusters of interior datapoints, on-surface data points, and exterior datapoints using the dynamic data.

7. The distributed, automated, open-source software (OSS) deprecation-prediction process of claim 6 wherein the clusters are created with a density-based special clustering of applications with noise (DMSCAN) ML technique.

8. The distributed, automated, open-source software (OSS) deprecation-prediction process of claim 7 further comprising the step of generating a metric for a quality of the clusters for self-reinforcement against a baseline.

9. The distributed, automated, open-source software (OSS) deprecation-prediction process of claim 8 wherein the metric is generated using a Calinski-Harabasz/Variance Ratio Criterion.

10. The distributed, automated, open-source software (OSS) deprecation-prediction process of claim 9 wherein the static data and the dynamic data are analyzed by an Ordering Points to Identify a Clustering Structure (OPTICS) ML technique to identify vectors trending toward the interior thereby suggesting an EOL candidate.

11. The distributed, automated, open-source software (OSS) deprecation-prediction process of claim 10 wherein the EOL deprecation prediction for the OS is a percentage of likelihood of deprecation within a time period based on prior deprecations that occurred within a prior time interval.

12. The distributed, automated, open-source software (OSS) deprecation-prediction process of claim 11 wherein the OSS indicia and OSS metadata is retrieved from all of said open-source repositories that are publicly accessible.

13. A distributed, automated, open-source software (OSS) deprecation-prediction process comprising the steps of:
retrieving, from all publicly available open-source repositories in cloud-service providers, OSS indicia and OSS metadata by a machine learning (ML) retrieval module;
storing, in a master OSS datastore, the OSS indicia and corresponding OSS metadata;
extracting, from the master OSS datastore based on selected criteria, a subset of the OSS metadata by ML;
normalizing, the subset of the OSS metadata, into normalized OSS metadata by a ML normalization module;
performing, on the normalized OSS metadata, ML data typification to create static data snapshots by a ML data typification module;
storing, in a static datastore, the static data snapshots, and providing the static data snapshots to: a ML surface analytics module, a ML cluster analytics module, and a dynamic data store;
performing, on the static data snapshots, surface analysis by the ML surface analytics module to generate a rolling time-series n-space vector map and cluster analysis by the ML cluster analytics module to generate time-based cluster analysis data;
integrating, into dynamic data in a dynamic data store, the rolling time-series n-space vector map and the time-based cluster analysis data;
providing, by the surface analytics module to the cluster analytics module, the rolling time-series n-space vector map;
providing, by the cluster analytics module to an end-of-life (EOL) analytics module, the cluster analysis; and
generating, by the EOL analytics module based on dynamic data, an EOL deprecation prediction for the OSS.

14. The distributed, automated, open-source software (OSS) deprecation-prediction process of claim 13 wherein the EOL deprecation prediction is based on an Ordering Points To Identify Clustering Structure (OPTICS)) machine learning technique for vectors trending toward the interior.

15. The distributed, automated, open-source software (OSS) deprecation-prediction process of claim 14 wherein the cluster analytics module creates clusters of interior, on-surface, and exterior data points as part of the time-based cluster analysis data.

16. The distributed, automated, open-source software (OSS) deprecation-prediction process of claim 15 wherein the cluster analytics module creates the clusters using a density-based spatial clustering of applications with noise (DBSCAN) machine learning technique.

17. The distributed, automated, open-source software (OSS) deprecation-prediction process of claim 16 wherein the cluster analytics module generates a metric for cluster quality for self-reinforcement against at least one baseline.

18. The distributed, automated, open-source software (OSS) deprecation-prediction process of claim 17 wherein the metric is generated using a Calinski-Harabasz/Variance Ratio Criterion.

19. The distributed, automated, open-source software (OSS) deprecation-prediction process of claim 18 wherein the EOL deprecation prediction is visually presented.

20. A distributed, automated, open-source software (OSS) deprecation-prediction process comprising the steps of:
retrieving, from all publicly available open-source repositories in cloud-service providers, OSS indicia and OSS metadata by a machine learning (ML) retrieval module;
storing, in a master OSS datastore, the OSS indicia and corresponding OSS metadata;
extracting, from the master OSS datastore based on selected criteria, a subset of the OSS metadata by ML;
normalizing, the subset of the OSS metadata, into normalized OSS metadata by a ML normalization module;
performing, on the normalized OSS metadata, ML data typification to create static data snapshots by a ML data typification module;
storing, in a static datastore, the static data snapshots, and providing the static data snapshots to: a ML surface analytics module, a ML cluster analytics module, and a dynamic data store;
performing, on the static data snapshots, surface analysis by the ML surface analytics module to generate a rolling time-series n-space vector map and cluster analysis by the ML cluster analytics module to generate time-based cluster analysis data that includes clusters of interior, on-surface, and exterior data points, and generates a metric for cluster quality for self-reinforcement against at least one baseline, said metric generated using a Calinski-Harabasz/Variance Ratio Criterion;
integrating, into dynamic data in a dynamic data store, the rolling time-series n-space vector map and the time-based cluster analysis data;
providing, by the surface analytics module to the cluster analytics module, the rolling time-series n-space vector map;
providing, by the cluster analytics module to an end-of-life (EOL) analytics module, the cluster analysis; and
generating, by the EOL analytics module based on the dynamic data, an EOL deprecation prediction for the OSS based on an Ordering Points To Identify Clustering Structure (OPTICS) machine learning technique for vectors trending toward the interior, said EOL deprecation prediction being visually presented.
